(19) United States
(12) Patent Application Publication
(10) Pub. No.: US 2017/0140297 A1
(43) Pub. Date: May 18, 2017

(54) GENERATING EFFICIENT SAMPLING STRATEGY PROCESSING FOR BUSINESS DATA RELEVANCE CLASSIFICATION

(71) Applicant: International Business Machines Corporation, Armonk, NY (US)

(72) Inventors: Sushama Karumanchi, State College, PA (US); Sunhwan Lee, Menlo Park, CA (US); Mu Qiao, Belmont, CA (US); Ramani R. Routray, San Jose, CA (US)

(21) Appl. No.: 14/943,915

(22) Filed: Nov. 17, 2015

(51) Int. Cl. G06N 99/00

(52) U.S. Cl. CPC G06N 99/005

(57) ABSTRACT

A method for performing efficient data sampling across a storage stack for training machine learning (ML) models. The method includes obtaining, by a processor, data. The processor clusters the data into clusters based on similarities of the obtained data across an entire storage stack including: storage infrastructure metrics, file metrics and application dependency taxonomy. The processor performs a random sampling process to sample representative data from each cluster. The sampled representative data are combined to generate training data for processing predictive analytics.

### BACKGROUND

Embodiments of the invention relate to data relevance classification, in particular, for sampling processing for data relevance classification to identify training data that is sampled across an entire stack for cloud-readiness determinations.

Data classification allows organizations to categorize data by business relevance and sensitivity in order to maintain the confidentiality and integrity of their data. Data classification helps organizations perform business value assessment and determine what data is appropriate to be stored on premises, migrated off-premises or disposed. However, data classification is a memory usage intensive activity (i.e., high memory usage and/or processing latency “cost”). For example, in large organizations, data is usually stored and secured by many repositories or databases in different geo locations, which may have different data privacy and regulatory compliance. Various security access approvals have to be obtained in order to obtain access to these data. In addition, a lot of new business or working models are emerging in modern organizations, such as BYOD (bring your own device), social media engagement, cloud, mobility, and crowdsourcing, which have posed many challenges to data classification. A data explosion in this big data is currently occurring. For example, it is estimated that YOUTUBE® users upload 72 hours of new video content and INSTAGRAM® users post nearly 220,000 new photos every minute. Additionally, large-scale business data are generated in real-time in the current workplace.

### SUMMARY

Embodiments of the invention relate to sampling processing for data relevance classification to identify training data that is sampled across an entire stack for cloud-readiness determinations. In one embodiment, a method includes obtaining, by a processor, data. The processor clusters the data into clusters based on similarities of the obtained data across an entire storage stack including: storage infrastructure metrics, file metrics and application dependency taxonomy. The processor performs a random sampling process to sample representative data from each cluster. The sampled representative data are combined to generate training data for processing predictive analytics.

These and other features, aspects and advantages of the present invention will become understood with reference to the following description, appended claims and accompanying figures.

### BRIEF DESCRIPTION OF THE DRAWINGS

FIG. 1 depicts a cloud computing environment, according to an embodiment;

FIG. 2 depicts a set of abstraction model layers, according to an embodiment;

FIG. 3 is a block diagram illustrating a processing system for performing efficient data sampling across a storage stack for training machine learning (ML) models, according to an embodiment;

FIG. 4 illustrates a flow diagram for generating data points across the entire stack, according to one embodiment;

FIG. 5 illustrates an example flow diagram for business relevance classification and data migration, according to one embodiment;

FIG. 6 illustrates an example flow diagram for a machine learning (ML) approach for predicting example business relevance, according to one embodiment;

FIG. 7 illustrates an example flow diagram for clustering based sampling, according to one embodiment;

FIG. 8 illustrates an example flow diagram for progressive sampling, according to one embodiment;

FIG. 9 illustrates a block diagram of a process for performing efficient data sampling across a storage stack for training ML models, according to one embodiment; and

FIG. 10 illustrates a block diagram for another process for performing efficient data sampling across a storage stack for training ML models, according to one embodiment.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is understood in advance that although this disclosure includes a detailed description of cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines (VMs), and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed and automatically, without requiring human interaction with the service's provider.

Broad network access: capabilities are available over a network and accessed through standard mechanisms that promote use by heterogeneous, thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned and, in some cases, automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported, thereby providing transparency for both the provider and consumer of the utilized service.

Service Models are as follows:

Software as a Service (SaaS): the capability provided to the consumer is the ability to use the provider's applications running on a cloud infrastructure. The applications are accessible from various client devices through a thin client interface, such as a web browser (e.g., web-based email). The consumer does not manage or control the underlying cloud infrastructure including network, servers, operating systems, storage, or even individual application capabilities, with the possible exception of limited consumer-specific application configuration settings.

Platform as a Service (PaaS): the capability provided to the consumer is the ability to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is the ability to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is a service oriented with a focus on statelessness, low coupling, modularity, and semantic interoperability. At the heart of cloud computing is an infrastructure comprising a network of interconnected nodes.

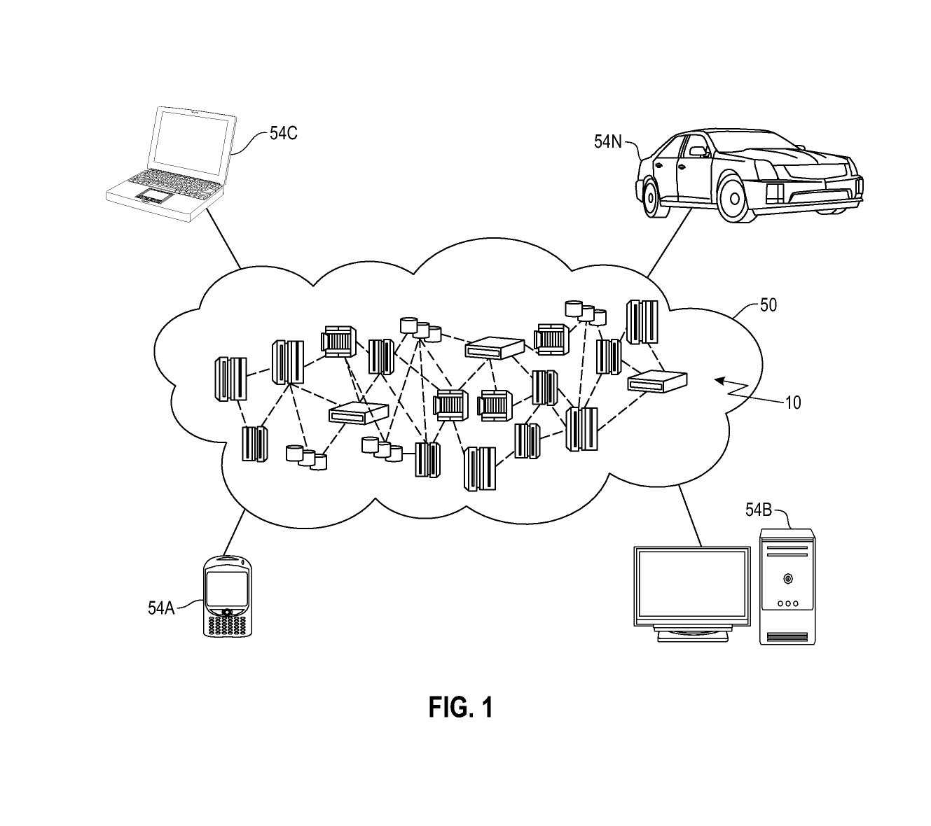

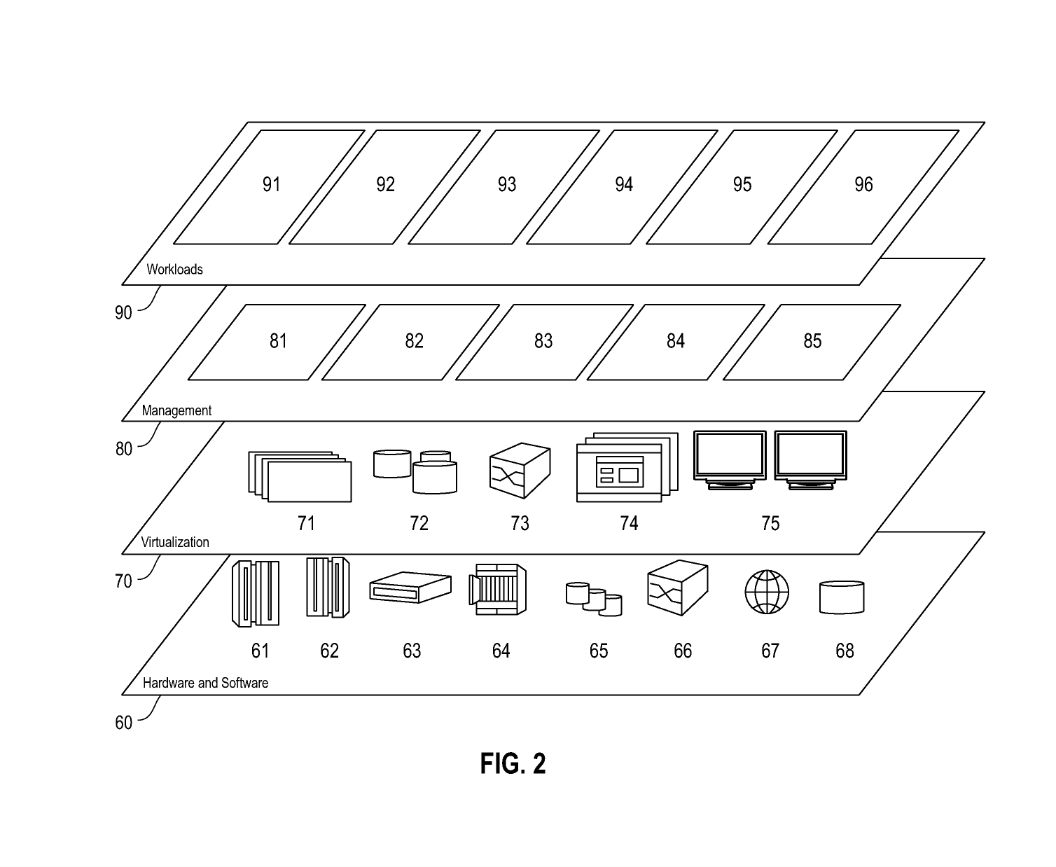

Referring now to FIG. 1, an illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as private, community, public, or hybrid clouds as described hereinabove, or a combination thereof. This allows the cloud computing environment 50 to offer infrastructure, platforms, and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

Referring now to FIG. 2, a set of functional abstraction layers provided by the cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, a management layer 80 may provide the functions described below. Resource provisioning 81 provides dynamic procurement of computing resources and other resources that are utilized to perform tasks within the cloud computing environment. Metering and pricing 82 provide cost tracking as resources are utilized within the cloud computing environment and billing or invoicing for consumption of these resources. In one example, these resources may comprise application software licenses. Security provides identity verification for cloud consumers and tasks as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95 and sampling processing for data relevance classification to identify training data that is sampled across an entire stack for cloud-readiness determinations 96. As mentioned above, all of the foregoing examples described with respect to FIG. 2 are illustrative only, and the invention is not limited to these examples.

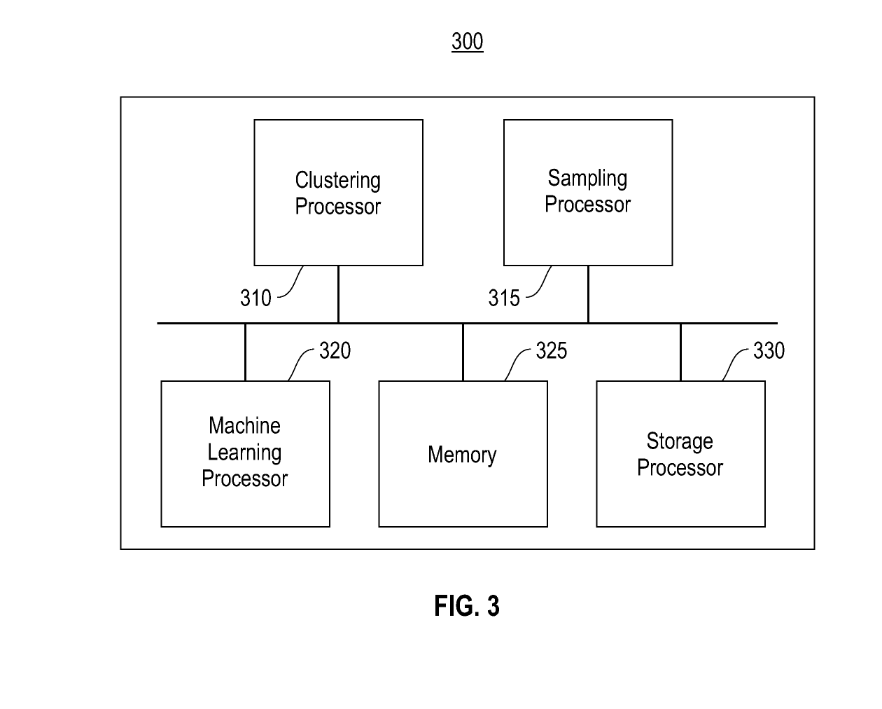

It is understood all functions of one or more embodiments as described herein may be typically performed by the processing system 300 (FIG. 3), which can be tangibly embodied as hardware processors and with modules of program code. However, this need not be the case. Rather, the functionality recited herein could be carried out/implemented and/or enabled by any of the layers 60, 70, 80 and 90 shown in FIG. 2.

It is reiterated that although this disclosure includes a detailed description on cloud computing, implementation of the teachings recited herein are not limited to a cloud computing environment. Rather, the embodiments of the present invention may be implemented with any type of clustered computing environment now known or later developed.

Embodiments of the invention relate to sampling processing for data relevance classification to identify machine learning (ML) training data that is sampled across an entire stack for cloud-readiness determinations. In one embodiment, a method includes obtaining, by a processor, data (e.g., business type of data). The processor clusters the data into clusters based on similarities of the obtained data across an entire storage stack including: storage infrastructure metrics, file metrics and application dependency taxonomy. The processor performs a random sampling process to sample representative data from each cluster. The sampled representative data are combined to generate training data for processing predictive analytics.

One or more embodiments provide an efficient data sampling strategy across three layers (storage, files [metadata, content], and applications), in order to train an effective prediction model for data (e.g., business data) relevance classification (e.g., confidential data, non-confidential data, etc.). In one embodiment, an efficient data sampling strategy for business data relevance classification advises and identifies the sample data that may be used for ML training in order to create rules for making cloud-readiness predictions for data migration. The in-depth scanning of file content to identify data confidentiality is a very system “costly” operation regarding memory usage and processing time, especially, when the file size and total number of files are extremely large-scale. One or more embodiments reduces memory usage and processing latency for the classification problem through a predictive analytics approach. In one embodiment, the prediction model (e.g., ML process) is trained by using features across storage infrastructure metrics, file metadata, and applications, which are much easier and faster to obtain, when comparing with the processing of entire file content. In one embodiment, a key issue of training an ML prediction model is to have a training data set that could well present the characteristics of the feature space, while the procurement “cost” of memory usage and processing latency should be within predetermined thresholds or bounds.

One or more embodiments employ a clustering-based sampling component to group data points into clusters across three layers (storage infrastructure metrics, file metadata, and applications). Representative points are selected from each cluster. In one embodiment, the corresponding file content of each point is processed in order to determine its confidentiality label. The union of these points comprise the initial training set. In one embodiment, a progressive sampling component gradually increases the sampling size in each cluster until no further prediction accuracy improvement is observed.

FIG. 3 is a block diagram illustrating a processing system 300 (e.g., a computing system hardware processor device, a multiprocessor, compilation system processor, etc.) for sampling processing for data relevance classification to identify ML training data that is sampled across an entire stack for cloud-readiness determinations, according to one embodiment. In one embodiment, the processing system 300 includes a clustering processor 310, a sampling processor 315, an ML processor 320, a memory device(s) 325 and a storage processor 330. In one embodiment, the processing system 300 is connected with one or more memory devices 325 (e.g., storage disk devices, storage systems, etc.).

In one embodiment, data, such as business entity data (or other types of data, such as social networking data that may be classified, e.g., private or public, etc.) is received into the memory 325 using the storage processor 330. In one embodiment, the clustering processor 310 clusters the data into multiple clusters based on similarities of the obtained data across an entire storage stack including: storage infrastructure metrics (e.g., input/output (I/O) rate, Read/Write permissions, Response time, etc.), file metrics (e.g., metadata: file type, file name, last modified date, owner, permissions, access traits, top users, etc.) and application dependency taxonomy (e.g., type of application: word processing application, email application, spreadsheet application, presentation type of application, etc.). In one or more embodiments, the storage infrastructure metrics, file metrics and application dependency taxonomy are used instead of entire file content for reducing sampling processing time and memory 325 requirements.

In one embodiment, the sampling processor 315 randomly samples representative data from each cluster. In one embodiment, the sampling processor 315 progressively samples the clusters by incrementing a sampling size in each cluster. The sampling processor 315 continues to progressively sample the clusters until a prediction accuracy threshold is met by training a prediction model using the sampled data or until a sampling memory usage threshold has been met. In one example, the prediction accuracy threshold may be replaced with a comparison of progressive accuracies. When the accuracy converges or does not improve, the progressive sampling stops at that point for output of the sampled data and the trained ML model from a previous progressive sampling iteration. In one embodiment, the sampling processor 315 samples the clusters with a first sampling percentage, applies a previous clustering-based sampling to obtain a training data set, and combines the training data set with previous determined training data. In one example, the first sampling percentage may be a percentage increment, a percentage of all samples, a predetermined percentage, etc.

In one embodiment, the ML processor 320 trains an ML model and obtains a classification accuracy for the ML model on a held-out test data set or using k-fold cross validation on the obtained training data set, and compares the classification accuracy with an accuracy from a previous sampling of the data. In one embodiment, upon a determination by the ML processor 320 that the classification accuracy improves over the accuracy from the previous sampling of the data, the ML processor 320 performs incremental sampling to a second sampling percentage (e.g., higher than the first percentage). Upon a determination by the ML processor 320 that the classification accuracy converges or does not improve over the accuracy from the previous sampling of the data, or a total sampling size is larger than a predetermined sampling size threshold, the system 300 outputs the sampled data and the trained ML model from a previous progressive sampling iteration.

In one embodiment, the ML processor 320 combines the sampled representative data to generate training data for processing predictive analytics. In one embodiment, the ML processor 320 predicts data relevance, such as business data relevance (e.g., classified/unclassified, secure/unsecure, sensitive/non-sensitive, etc.) by learning from the sampled training data to predict different categories (e.g., classified, unclassified; private, public, etc.). In one embodiment, the ML processor 320 may use support vector machines (SVM), logistic Regression, Naïve Bayes, etc. In one embodiment, the ML processor 320 uses predictive analytics to perform a cloud-readiness recommendation for moving the data offsite to cloud-based storage. The ML processor 320 uses ML processing models to learn from the training data for predicting different categories for the data.

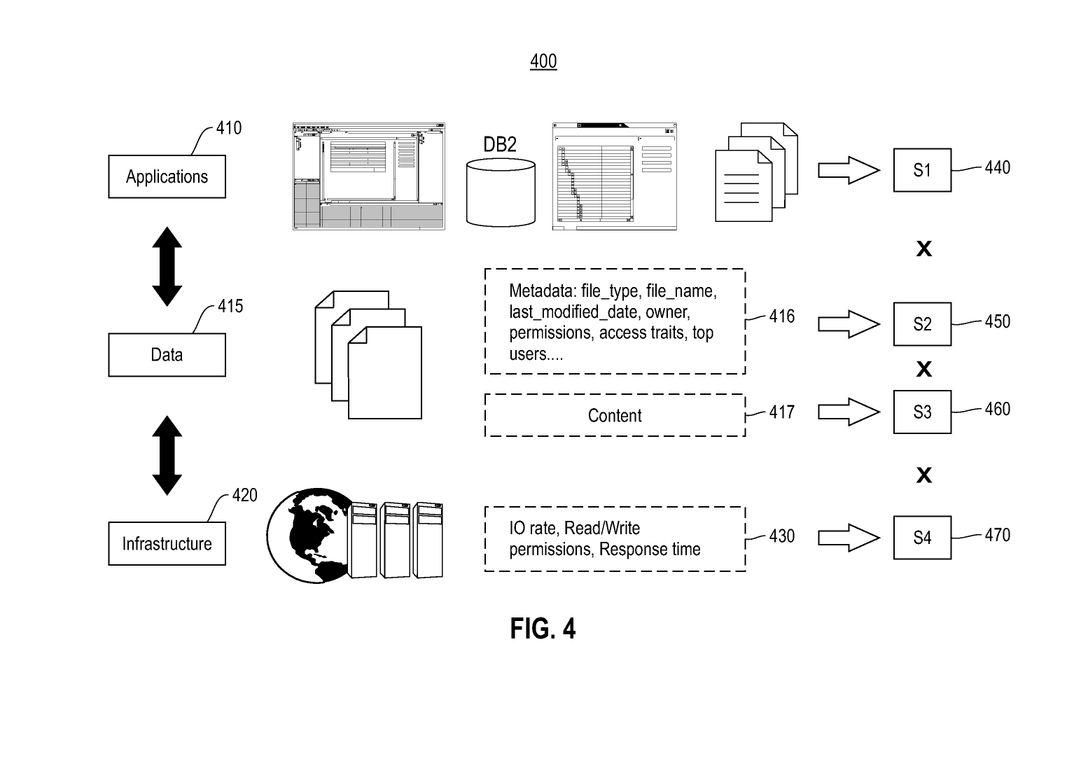

FIG. 4 illustrates a flow diagram 400 for generating data points across the entire stack (e.g., storage infrastructure metrics, file metric and application dependency taxonomy), according to one embodiment. In one embodiment, the processing (e.g., using processing system 300, FIG. 3) generates data points across the entire stack of storage infrastructure 420 (including information 430: I/O rate, Read/Write permissions, response time, etc.) file data 415 (metadata 416 and content 417) and applications 410. S1 440 denotes the data corresponding to the application dependency taxonomy; S2 450 denotes the data related with file metadata; S3 460 denotes file content; S4 470 denotes storage infrastructure metrics.

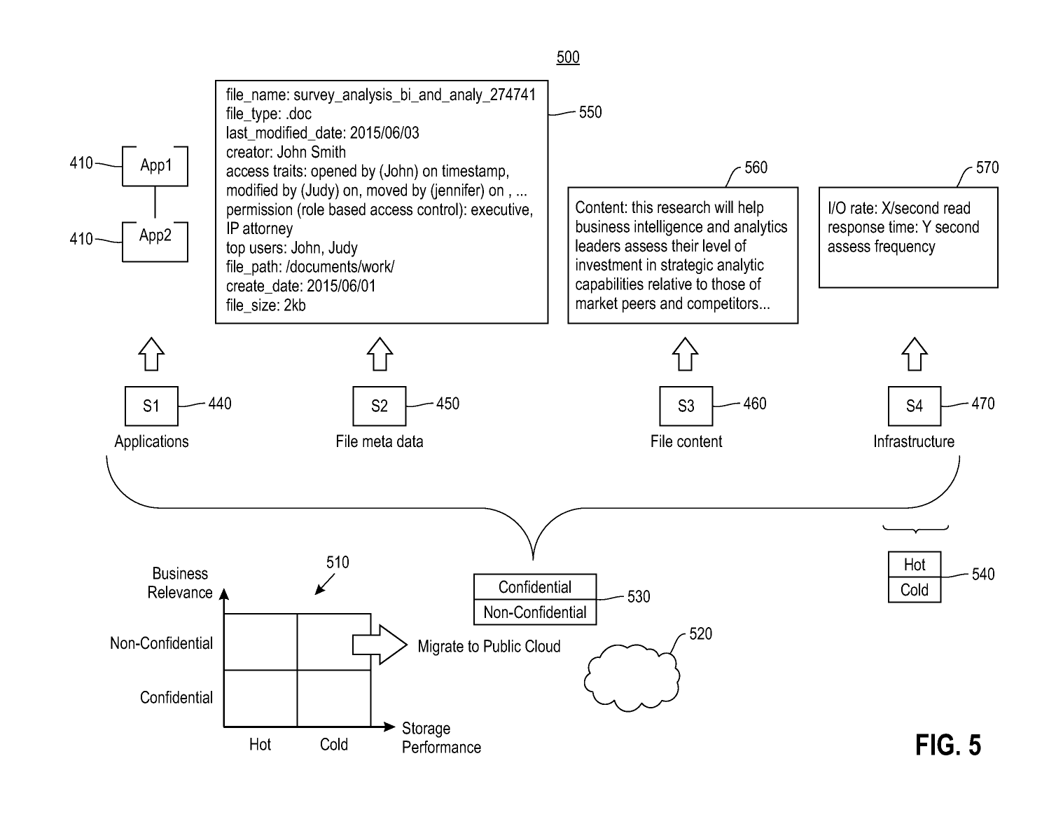

FIG. 5 illustrates an example flow diagram 500 for business relevance classification and data migration, according to one embodiment. In one example S1 440 includes the data corresponding to App1 and App2. S2 450 includes data 550 for an example file that includes the following:

file_name: survey_analysis_bi_and_analy_274741

file_type: .doc

last_modified_date: 2015/06/03

creator: John Smith

access traits: opened by (John) on timestamp, modified by (Judy) on, moved by (Jennifer) on, . . .

permission (role based access control): executive, IP attorney

top users: John, Judy

file_path: /documents/work

create_date: 2015/06/01

file_size: 2 kb.

S3 460 includes example data 560 of: Content: This research will help business intelligence and analytics leaders assess their level of investment in strategic analytic capabilities relative to those of market peers and competitors . . . S4 470 includes storage infrastructure metrics data 570 of:

I/O rate: X/second

Read

Response time: Y second

Access frequency.

In one embodiment, from S1 440, S2 450, S3 460 and S4 470 the processing system determines whether the business data is, for example, business relevance classification (e.g., confidential/non-confidential) 530, and whether the storage performance 540 is hot/cold. The graph 510 shows the business relevance classification 530 versus storage performance 540, where a rule is generated to migrate data that is non-confidential and cold to a public cloud 520.

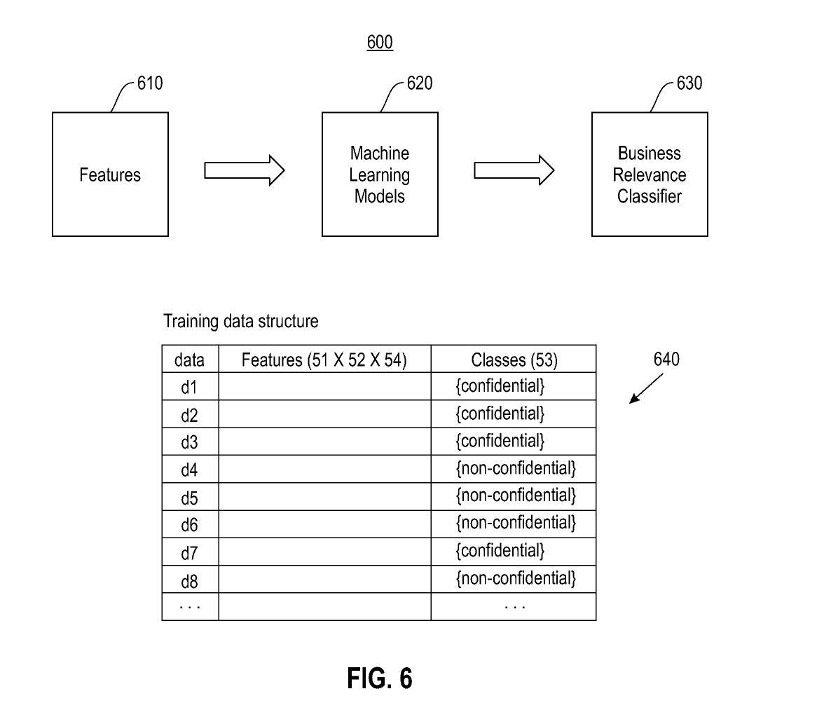

FIG. 6 illustrates an example flow diagram 600 for an ML approach for predicting example business relevance, according to one embodiment. In one embodiment, the training data with features 610 are obtained across the feature space S1 440×S2 450×S4 470 (FIG. 4), while classes of the training data structure 640 are obtained by processing the file content S3 460. In one embodiment, the training data with features 610 has class labels assigned by processing the actual file content (S3 460). In one embodiment, the ML models 620 “learn” from the sample training data to predict different categories for the data. In one embodiment, the business relevance classifier 630 is a trained classifier and predicts business relevance (e.g., confidential/non-confidential). The training data structure 640 that is generated by the processing system (e.g., processing system 300, FIG. 3) includes the data identifier, the features S1 440×S2 450×S4 470 and the class labels assigned by S3 460.

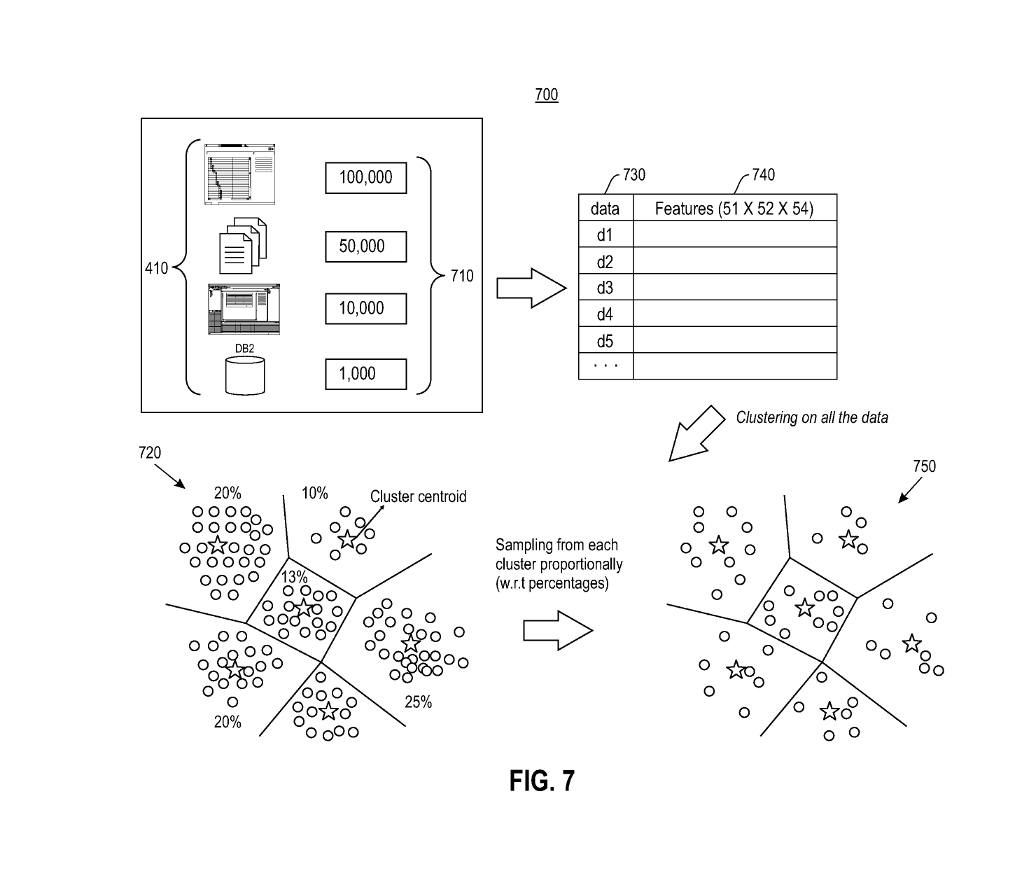

FIG. 7 illustrates an example flow diagram 700 for clustering based sampling, according to one embodiment. In one embodiment, the clustering based sampling component provides for clustering all the data points across the feature space (S1 440×S2 450×S4 470, FIG. 4) using data 730 and the feature space of the training data structure 640 (FIG. 6), obtains the cluster centroids 720 and computes the percentage of data assigned to each cluster shown as 750. In one embodiment, the clustering may use Vertex Substitution Heuristic (VSH) processing, which is a distance-based clustering algorithm. In another embodiment, K-means or other clustering algorithms which clusters data points in a vector space can also be used since the data points 410 are also described in feature vectors. In one embodiment, random sampling is performed from each cluster proportionally with respect to the previously obtained percentage. In one example, suppose the total number of data points 410 is 161,000, the percentage of data in cluster 1 is 20%, and it is desired to randomly sample 5% of the entire data as training. The final number of sampled data from cluster 1 is therefore 161,000×20%×5%=1,610. Note that the cluster centroid can always be selected by the processing system (e.g., processing system 300, FIG. 3) since it is a natural representation for the whole cluster.

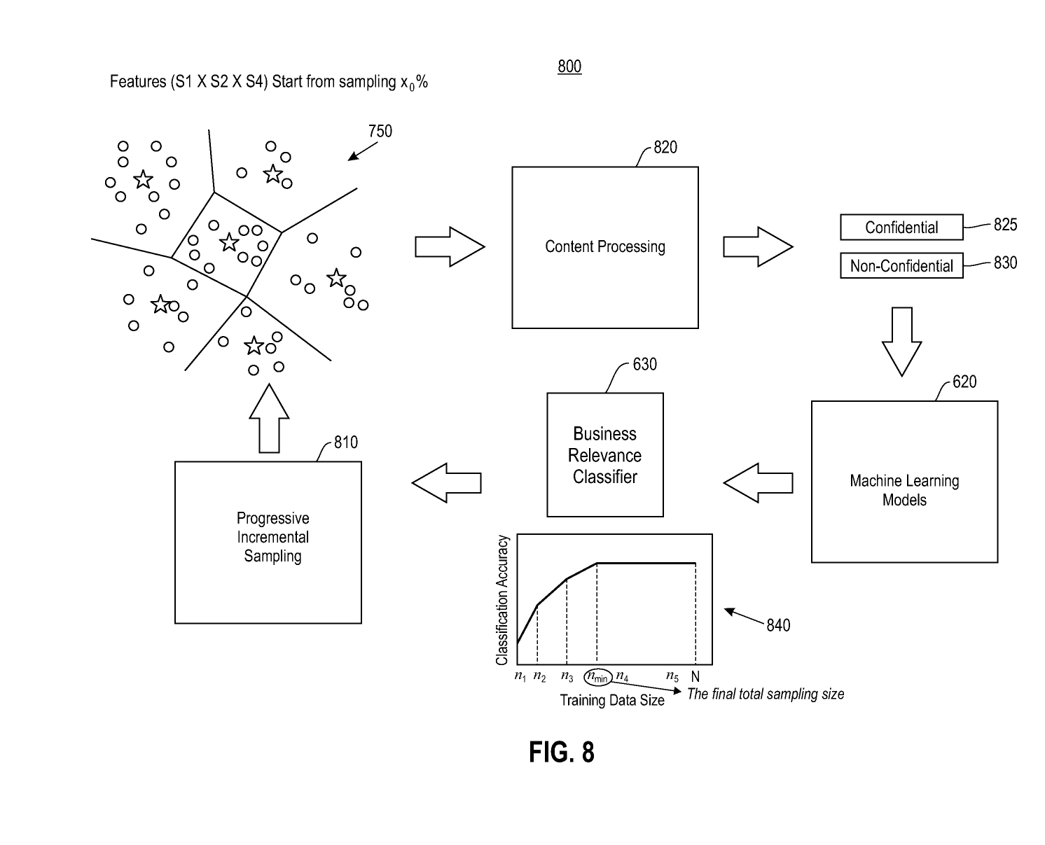

FIG. 8 illustrates an example flow diagram 800 for progressive sampling, according to one embodiment. In one embodiment, a progressive incremental sampling processing 810 component determines the final total sampling size. In one embodiment, if the classification accuracy at the i^{th} (where i is a positive integer) running improves, the progressive incremental sampling processing 810 proceeds to perform incremental sampling Δxᵢ%. If the accuracy converges or does not improve in an incremental sampling, or the total sampling size exceeds a predetermined threshold, the progressive incremental sampling processing 810 stops and the total sampling size at the previous iteration is output.

In one embodiment, the progressive incremental sampling processing 810 starts from a relatively small sampling percentage. The previous clustering-based sampling is applied to obtain a training data set 750, which is combined with existing training data. Content processing 820 processes the actual content of a data file (S3 460, FIG. 4) and applies keywords for pattern matching to determine, for example, confidentiality. In one example, the keywords are selected from a predefined dictionary including relevant words (e.g., internal, do not disclose, confidential, snn, sensitive, etc., with stemming, negation, synonym mapping, etc.). The output of the content processing (confidential 825 and non-confidential 830) is input to train a machine learning model(s) 620 and obtain its classification accuracy 840 on a held-out test dataset or using k-fold cross validation on all the obtained training data. The ML model(s) output is input to the business relevance classifier 630. In one embodiment, the resulting accuracy is compared with the accuracy from the previous running (set the previous accuracy to 0 for the first running) If the accuracy improves, then incremental sampling Δxᵢ is performed. If the accuracy converges or does not improve, or the total sampling size is larger than a predetermined threshold (beyond the memory usage and/or processing latency), the progressive incremental sampling processing 810 stops and outputs the sampled data and the trained machine learning model at the previous step.

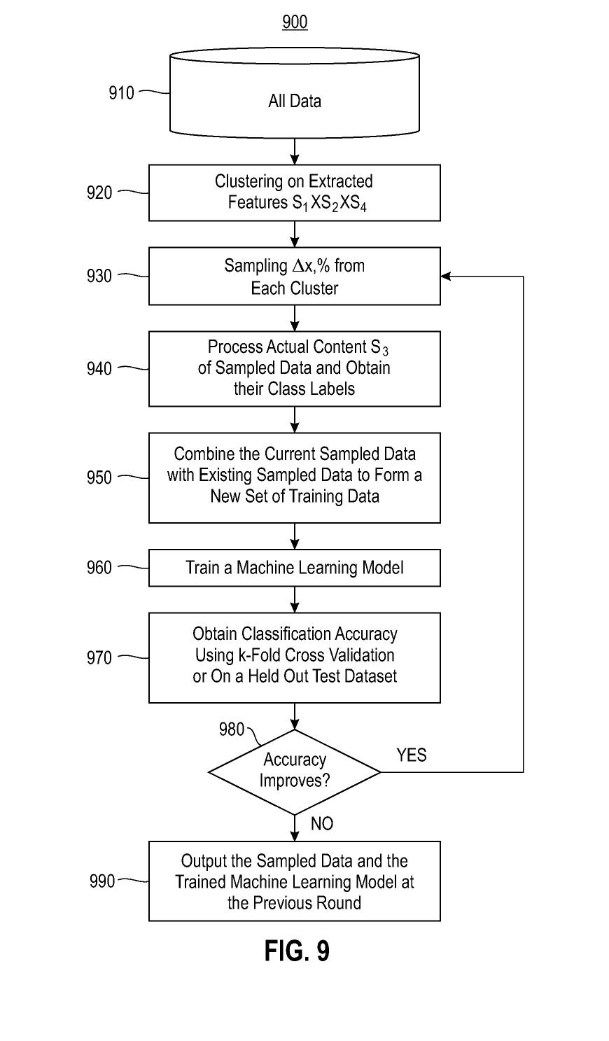

FIG. 9 illustrates a block diagram of a process 900 for performing efficient data sampling across a storage stack for training ML models, according to one embodiment. In one embodiment, the process 900 is performed by the processing system 300 (FIG. 3). In one embodiment, in block 910 all of the data to be processed is obtained and stored in memory. In block 920, process 900 performs clustering on features (S1 440×S2 450×S4 470, FIG. 4) extracted from the data. In block 930 sampling Δxᵢ is performed from each cluster. In block 940 the actual content S3 460 of the sampled data is processed to obtain the respective classification labels. In block 950 the current sampled data is combined with existing sampled data to form a new set of training data. In block 960 the ML model(s) is trained using the set of training data. In block 970 classification accuracy is determined using k-fold cross validation or on a held out test dataset. In block 980 it is determined whether the accuracy improves or converges or does not improve. If the accuracy improves, process 900 proceeds to block 930, otherwise process 900 proceeds to block 990. In block 990, process 900 outputs the sampled data and the trained ML model at for the previous processing iteration.

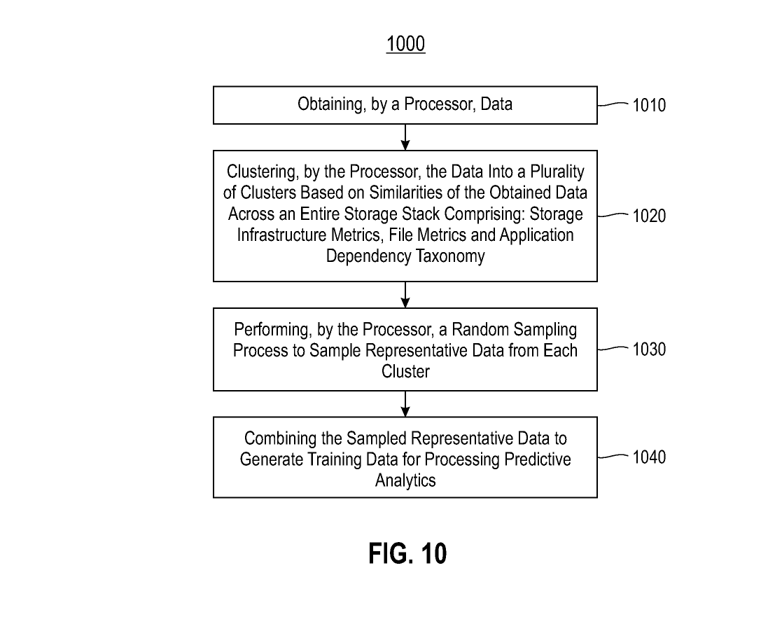

FIG. 10 illustrates a block diagram for another process 1000 for performing efficient data sampling across a storage stack for training ML models, according to one embodiment. In one embodiment, in block 1010 a processor (e.g., the clustering processor 310, FIG. 3) obtains data to be processed (e.g., and the storage processor 330 stores the data in the memory 325). In block 1020, process 1000 clusters (by the processor) the data into multiple clusters based on similarities of the obtained data across an entire storage stack comprising: storage infrastructure metrics, file metrics and application dependency taxonomy. In block 1030, process 1000 performs a random sampling process using the processor to sample representative data from each cluster. In block 1040, the sampled representative data is combined to generate training data for processing predictive analytics.

In one embodiment, process 1000 may include progressively sampling the multiple clusters by incrementing a sampling size in each cluster. In one embodiment, process 1000 may continue to progressively sample until a prediction accuracy threshold is met by training a prediction model using the sampled data or until a sampling memory usage threshold has been met. In one embodiment, in process 1000 the predictive analytics are used to perform a cloud-readiness recommendation for moving the data offsite to cloud-based storage. In one embodiment, process 1000 may provide that ML processing models are used to learn from the training data for predicting different categories for the data.

In one embodiment, process 1000 uses the storage infrastructure metrics, file metrics and application dependency taxonomy instead of entire file content for reducing sampling processing time and required memory, as well as avoiding applying security access approval which is “cost” expensive. In one embodiment, process 1000 may perform progressive sampling of the multiple clusters by sampling the multiple clusters with a first sampling percentage, applying a previous clustering-based sampling to obtain a training data set, combining the training data set with previous determined training data, training an ML model and obtaining a classification accuracy for the ML model on a held-out test data set or using k-fold cross validation on the obtained training data set, and comparing the classification accuracy with an accuracy from a previous sampling of the data.

In one embodiment, process 1000 may further include performing progressive sampling of the multiple clusters by determining if classification accuracy improves over the accuracy from the previous sampling of the data, and if so process 1000 performs incremental sampling to a second sampling percentage. In one embodiment, if the determination results with the classification accuracy converges or is not showing improvement over the accuracy from the previous sampling of the data, or a total sampling size is larger than a predetermined sampling size threshold, process 1000 may output the sampled data and the trained ML model from a previous progressive sampling iteration.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
obtaining, by a processor, data;
clustering, by the processor, the data into a plurality of clusters based on similarities of the obtained data across an entire storage stack comprising: storage infrastructure metrics, file metrics and application dependency taxonomy;
performing, by the processor, a random sampling process to sample representative data from each cluster; and
combining the sampled representative data to generate training data for processing predictive analytics.

2. The method of claim 1, further comprising:
progressively sampling the plurality of clusters by incrementing a sampling size in each cluster.

3. The method of claim 2, wherein progressively sampling continues until a prediction accuracy threshold is met by training a prediction model using the sampled data or until a sampling memory usage threshold has been met.

4. The method of claim 3, wherein the predictive analytics are used to perform a cloud-readiness recommendation for moving the data offsite to cloud-based storage.

5. The method of claim 4, wherein machine learning (ML) processing models are used to learn from the training data for predicting different categories for the data.

6. The method of claim 1, wherein the storage infrastructure metrics, file metrics and application dependency taxonomy are used instead of entire file content for reducing sampling processing time.

7. The method of claim 2, wherein progressively sampling the plurality of clusters comprises:
sampling the plurality of clusters with a first sampling percentage;
applying a previous clustering-based sampling to obtain a training data set, and combining the training data set with previous determined training data;
training a machine learning (ML) model and obtaining a classification accuracy for the ML model on a held-out test data set or using k-fold cross validation on the obtained training data set; and
comparing the classification accuracy with an accuracy from a previous sampling of the data.

8. The method of claim 7, wherein progressively sampling the plurality of clusters further comprises:
upon a determination that the classification accuracy improves over the accuracy from the previous sampling of the data, perform incremental sampling to a second sampling percentage; and
upon a determination that the classification accuracy converges or does not improve over the accuracy from the previous sampling of the data, or a total sampling size is larger than a predetermined sampling size threshold, outputting the sampled data and the trained ML model from a previous progressive sampling iteration.

9. A computer program product for performing efficient data sampling across a storage stack for training machine learning (ML) models, the computer program product comprising a computer readable storage medium having program instructions embodied therewith, the program instructions executable by a processor to cause the processor to:
obtain, by the processor, data;
cluster, by the processor, the data into a plurality of clusters based on similarities of the obtained data across an entire storage stack comprising: storage infrastructure metrics, file metrics and application dependency taxonomy;
perform, by the processor, a random sampling process to sample representative data from each cluster; and
combine, by the processor, the sampled representative data to generate training data for processing predictive analytics.

10. The computer program product of claim 9, further comprising program instructions executable by the processor to cause the processor to:
progressively sample, by the processor, the plurality of clusters by incrementing a sampling size in each cluster.

11. The computer program product of claim 10, wherein the progressively sampling continues until a prediction accuracy threshold is met by training a prediction model using the sampled data or until a sampling memory usage threshold has been met.

12. The computer program product of claim 11, wherein the predictive analytics are used to perform a cloud-readiness recommendation for moving the data offsite to cloud-based storage, and ML processing models are used to learn from the training data for predicting different categories for the data.

13. The computer program product of claim 9, wherein the storage infrastructure metrics, file metrics and application dependency taxonomy are used instead of entire file content for reducing sampling processing time.

14. The computer program product of claim 10, wherein progressively sampling of the plurality of clusters comprises program instructions executable by the processor to cause the processor to:
sample, by the processor, the plurality of clusters with a first sampling percentage;
apply, by the process, a previous clustering-based sampling to obtain a training data set, and combining the training data set with previous determined training data;
train, by the processor, an ML model and obtaining a classification accuracy for the ML model on a held-out test data set or using k-fold cross validation on the obtained training data set; and
compare, by the processor, the classification accuracy with an accuracy from a previous sampling of the data.

15. The computer program product of claim 14, wherein progressively sampling of the plurality of clusters comprises program instructions executable by the processor to cause the processor to:
upon a determination that the classification accuracy improves over the accuracy from the previous sampling of the data, perform, by the processor, incremental sampling to a second sampling percentage; and
upon a determination that the classification accuracy converges or does not improve over the accuracy from the previous sampling of the data, or a total sampling size is larger than a predetermined sampling size threshold, output, by the processor, the sampled data and the trained ML model from a previous progressive sampling iteration.

16. An apparatus comprising:
a storage device configured to receive data;
a clustering processor configured to cluster the data into a plurality of clusters based on similarities of the obtained data across an entire storage stack comprising: storage infrastructure metrics, file metrics and application dependency taxonomy;
a sampling processor configured to a randomly sample representative data from each cluster; and
a machine learning (ML) processor configured to combine the sampled representative data to generate training data for processing predictive analytics.

17. The apparatus of claim 16, wherein the sampling processor is further configured to:
progressively sample the plurality of clusters by incrementing a sampling size in each cluster, wherein the sampling processor continues to progressively sample the plurality of clusters until a prediction accuracy threshold is met by training a prediction model using the sampled data or until a sampling memory usage threshold has been met.

18. The apparatus of claim 17, wherein:
the predictive analytics are used to perform a cloud-readiness recommendation for moving the data offsite to cloud-based storage;
ML processing models are used to learn from the training data for predicting different categories for the data; and
the storage infrastructure metrics, file metrics and application dependency taxonomy are used instead of entire file content for reducing sampling processing time.

19. The apparatus of claim 18, wherein:
the sampling processor is further configured to:
sample the plurality of clusters with a first sampling percentage;
apply a previous clustering-based sampling to obtain a training data set, and combining the training data set with previous determined training data; and
the ML processor is further configured to:
train an ML model and obtain a classification accuracy for the ML model on a held-out test data set or using k-fold cross validation on the obtained training data set; and
comparing the classification accuracy with an accuracy from a previous sampling of the data.

20. The apparatus of claim 19, wherein the ML processor is further configured to:
upon a determination that the classification accuracy improves over the accuracy from the previous sampling of the data, perform incremental sampling to a second sampling percentage; and
upon a determination that the classification accuracy converges or does not improve over the accuracy from the previous sampling of the data, or a total sampling size is larger than a predetermined sampling size threshold, output the sampled data and the trained ML model from a previous progressive sampling iteration.
